(19) United States
(12) Patent Application Publication
(10) Pub. No.: US 2020/0092763 A1
(43) Pub. Date: Mar. 19, 2020

(54) MULTI-OPERATOR HANDOVER IN NEW RADIO SHARED SPECTRUM

(71) Applicant: QUALCOMM Incorporated, San Diego, CA (US)

(72) Inventors: Srinivas Yerramalli, San Diego, CA (US); Vinay Joseph, San Diego, CA (US); Xiaoxia Zhang, San Diego, CA (US)

(21) Appl. No.: 16/569,419

(22) Filed: Sep. 12, 2019

Related U.S. Application Data
(60) Provisional application No. 62/732,346, filed on Sep. 17, 2018.

(51) Int. Cl. H04W 36/00; H04W 24/10; H04W 76/11

(52) U.S. Cl. CPC H04W 36/0061; H04W 36/00835; H04W 76/11; H04W 24/10; H04W 36/0058

(57) ABSTRACT

Multi-operator handover is disclosed for new radio (NR) shared spectrum (NR-SS) operations. In order to facilitate inter-operator handover operations, a base station, after receipt of a measurement report from a served user equipment (UE) may selectively instruct the UE to search and report an operator identifier (ID) of one or more second operator neighboring cells. In alternative aspects, a UE may store such network information, including operator ID, of all neighboring cells it measures during an idle state and report the network information to the base station when connection is established. The base station may then store the operator IDs in an neighboring operator database. The base station may then provide the operator ID for the neighboring operator to a UE for consideration of handover in future handover operations.

### CROSS-REFERENCE TO RELATED APPLICATIONS

This application claims the benefit of U.S. Provisional Patent Application No. 62/732,346, entitled, “MULTI-OPERATOR HANDOVER IN NR-SS,” filed on Sep. 17, 2018, which is expressly incorporated by reference herein in its entirety.

### BACKGROUND

### Field

Aspects of the present disclosure relate generally to wireless communication systems, and more particularly, to multi-operator handover in new radio (NR) shared spectrum (NR-SS) operations.

### Background

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). Examples of multiple-access network formats include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### SUMMARY

In one aspect of the disclosure, a method of wireless communication includes receiving, at a base station, a measurement report from one or more served user equipments (UEs) of one or more neighboring cells, wherein the base station is operated by a first network operator, selectively instructing, by the base station, a served UE of the one or more served UEs to report an operator identifier (ID) of one or more second operator neighboring cells, wherein the one or more second operator neighboring cells are each operated by at least one other network operator other than the first network operator, and storing, by the base station, the operator ID in an neighboring operator database for each operator ID of the one or more second operator neighboring cells received from the served UE.

In an additional aspect of the disclosure, a transmitting, by a UE, a measurement report to a serving base station, wherein the measurement report identifies a quality and a cell ID of one or more neighboring cells, receiving, by the UE, instructions from the serving base station to report an operator ID of one or more second operator neighboring cells, wherein the one or more second operator neighboring cells are each operated by at least one other network operator other than the first network operator, searching, by the UE, for the operator ID of each of the one or more second operator neighboring cells according to the instructions, and reporting, by the UE, one or more operator IDs discovered in the searching.

In an additional aspect of the disclosure, a method of wireless communication includes measuring, by a UE during an idle state, one or more second operator neighboring cells, wherein the one or more second operator neighboring cells are each operated by at least one other network operator other than a first network operator associated with a last connection of the UE, storing, by the UE, network information associated with the one or more second operator neighboring cells, wherein the network information includes signal quality information generated during the measuring, establishing, by the UE, a connection with a serving base station associated with the first network operator, and transmitting, by the UE, a neighbor cell report to the serving base station, wherein the neighbor cell report includes at least a portion of the network information.

In an additional aspect of the disclosure, an apparatus configured for wireless communication includes means for receiving, at a base station, a measurement report from one or more served UEs of one or more neighboring cells, wherein the base station is operated by a first network operator, means for selectively instructing, by the base station, a served UE of the one or more served UEs to report an operator ID of one or more second operator neighboring cells, wherein the one or more second operator neighboring cells are each operated by at least one other network operator other than the first network operator, and means for storing, by the base station, the operator ID in an neighboring operator database for each operator ID of the one or more second operator neighboring cells received from the served UE.

In an additional aspect of the disclosure, an apparatus configured for wireless communication includes means for transmitting, by a UE, a measurement report to a serving base station, wherein the measurement report identifies a quality and a cell ID of one or more neighboring cells, means for receiving, by the UE, instructions from the serving base station to report an operator ID of one or more second operator neighboring cells, wherein the one or more second operator neighboring cells are each operated by at least one other network operator other than the first network operator, means for searching, by the UE, for the operator ID of each of the one or more second operator neighboring cells according to the instructions, and means for reporting, by the UE, one or more operator IDs discovered during execution of the means for searching.

In an additional aspect of the disclosure, an apparatus configured for wireless communication includes means for measuring, by a UE during an idle state, one or more second operator neighboring cells, wherein the one or more second operator neighboring cells are each operated by at least one other network operator other than a first network operator associated with a last connection of the UE, means for storing, by the UE, network information associated with the one or more second operator neighboring cells, wherein the network information includes signal quality information generated during execution of the means for measuring, means for establishing, by the UE, a connection with a serving base station associated with the first network operator, and means for transmitting, by the UE, a neighbor cell report to the serving base station, wherein the neighbor cell report includes at least a portion of the network information.

In an additional aspect of the disclosure, a non-transitory computer-readable medium having program code recorded thereon. The program code further includes code to receive, at a base station, a measurement report from one or more served UEs of one or more neighboring cells, wherein the base station is operated by a first network operator, code to selectively instruct, by the base station, a served UE of the one or more served UEs to report an operator ID of one or more second operator neighboring cells, wherein the one or more second operator neighboring cells are each operated by at least one other network operator other than the first network operator, and code to store, by the base station, the operator ID in an neighboring operator database for each operator ID of the one or more second operator neighboring cells received from the served UE.

In an additional aspect of the disclosure, a non-transitory computer-readable medium having program code recorded thereon. The program code further includes code to transmit, by a UE, a measurement report to a serving base station, wherein the measurement report identifies a quality and a cell ID of one or more neighboring cells, code to receive, by the UE, instructions from the serving base station to report an operator ID of one or more second operator neighboring cells, wherein the one or more second operator neighboring cells are each operated by at least one other network operator other than the first network operator, code to search, by the UE, for the operator ID of each of the one or more second operator neighboring cells according to the instructions, and code to report, by the UE, one or more operator IDs discovered during execution of the code to search.

In an additional aspect of the disclosure, a non-transitory computer-readable medium having program code recorded thereon. The program code further includes code to measure, by a UE during an idle state, one or more second operator neighboring cells, wherein the one or more second operator neighboring cells are each operated by at least one other network operator other than a first network operator associated with a last connection of the UE, code to store, by the UE, network information associated with the one or more second operator neighboring cells, wherein the network information includes signal quality information generated during execution of the code to measure, code to establish, by the UE, a connection with a serving base station associated with the first network operator, and code to transmit, by the UE, a neighbor cell report to the serving base station, wherein the neighbor cell report includes at least a portion of the network information.

In an additional aspect of the disclosure, an apparatus configured for wireless communication is disclosed. The apparatus includes at least one processor, and a memory coupled to the processor. The processor is configured to receive, at a base station, a measurement report from one or more served UEs of one or more neighboring cells, wherein the base station is operated by a first network operator, to selectively instruct, by the base station, a served UE of the one or more served UEs to report an operator ID of one or more second operator neighboring cells, wherein the one or more second operator neighboring cells are each operated by at least one other network operator other than the first network operator, and to store, by the base station, the operator ID in an neighboring operator database for each operator ID of the one or more second operator neighboring cells received from the served UE.

In an additional aspect of the disclosure, an apparatus configured for wireless communication is disclosed. The apparatus includes at least one processor, and a memory coupled to the processor. The processor is configured to transmit, by a UE, a measurement report to a serving base station, wherein the measurement report identifies a quality and a cell ID of one or more neighboring cells, to receive, by the UE, instructions from the serving base station to report an operator ID of one or more second operator neighboring cells, wherein the one or more second operator neighboring cells are each operated by at least one other network operator other than the first network operator, to search, by the UE, for the operator ID of each of the one or more second operator neighboring cells according to the instructions, and to report, by the UE, one or more operator IDs discovered during execution of the configuration to search.

In an additional aspect of the disclosure, an apparatus configured for wireless communication is disclosed. The apparatus includes at least one processor, and a memory coupled to the processor. The processor is configured to measure, by a UE during an idle state, one or more second operator neighboring cells, wherein the one or more second operator neighboring cells are each operated by at least one other network operator other than a first network operator associated with a last connection of the UE, to store, by the UE, network information associated with the one or more second operator neighboring cells, wherein the network information includes signal quality information generated during execution of the configuration to measure, to establish, by the UE, a connection with a serving base station associated with the first network operator, and to transmit, by the UE, a neighbor cell report to the serving base station, wherein the neighbor cell report includes at least a portion of the network information.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of a wireless communication system.

FIG. 2 is a block diagram illustrating a design of a base station and a UE configured according to one aspect of the present disclosure.

FIG. 3 is a block diagram illustrating a wireless communication system including base stations that use directional wireless beams.

FIGS. 4A and 4B are block diagrams illustrating example blocks executed to implement one aspect of the present disclosure.

FIG. 5 is a block diagram illustrating an overlapping wireless network including a base station and UE of a first operator, each configured according to aspects of the present disclosure.

FIG. 6 is a block diagram illustrating an overlapping wireless network, with a base station and UE of a first operator, each configured according to additional aspects of the present disclosure.

FIG. 7 is a block diagram illustrating example blocks executed to implement one aspect of the present disclosure.

FIG. 8 is a block diagram illustrating a base station configured according to one aspect of the present disclosure.

FIG. 9 is a block diagram illustrating a UE configured according to one aspect of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), IEEE 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., —1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

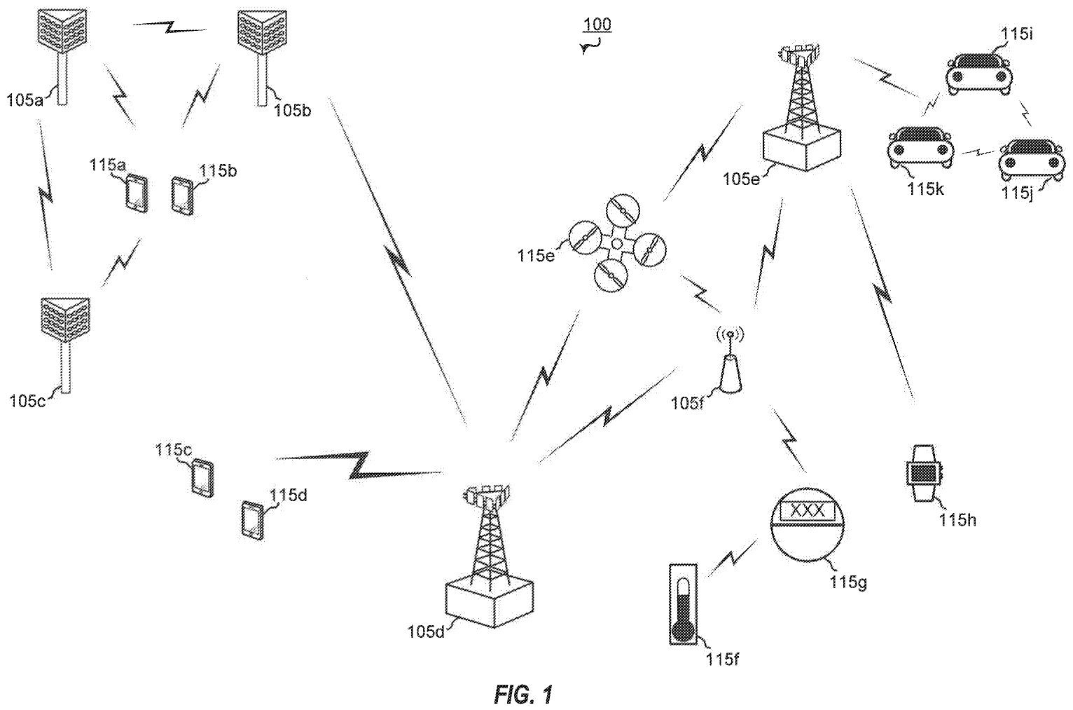

FIG. 1 is a block diagram illustrating 5G network 100 including various base stations and UEs configured according to aspects of the present disclosure. The 5G network 100 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station and/or a base station subsystem serving the coverage area, depending on the context in which the term is used.

A base station may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, the base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

The 5G network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time.

The UEs 115 are dispersed throughout the wireless network 100, and each UE may be stationary or mobile. A UE may also be referred to as a terminal, a mobile station, a subscriber unit, a station, or the like. A UE may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE may be a device that includes a Universal Integrated Circuit Card (UICC). In another aspect, a UE may be a device that does not include a UICC. In some aspects, UEs that do not include UICCs may also be referred to as internet of everything (IoE) or internet of things (IoT) devices. UEs 115a-115d are examples of mobile smart phone-type devices accessing 5G network 100 A UE may also be a machine specifically configured for connected communication, including machine type communication (MTC), enhanced MTC (eMTC), narrowband IoT (NB-IoT) and the like. UEs 115e-115k are examples of various machines configured for communication that access 5G network 100. A UE may be able to communicate with any type of the base stations, whether macro base station, small cell, or the like. In FIG. 1, a lightning bolt (e.g., communication links) indicates wireless transmissions between a UE and a serving base station, which is a base station designated to serve the UE on the downlink and/or uplink, or desired transmission between base stations, and backhaul transmissions between base stations.

In operation at 5G network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

5G network 100 also support mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through 5G network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. 5G network 100 may also provide additional network efficiency through dynamic, low-latency TDD/FDD communications, such as in a vehicle-to-vehicle (V2V) mesh network between UEs 115i-115k communicating with macro base station 105e.

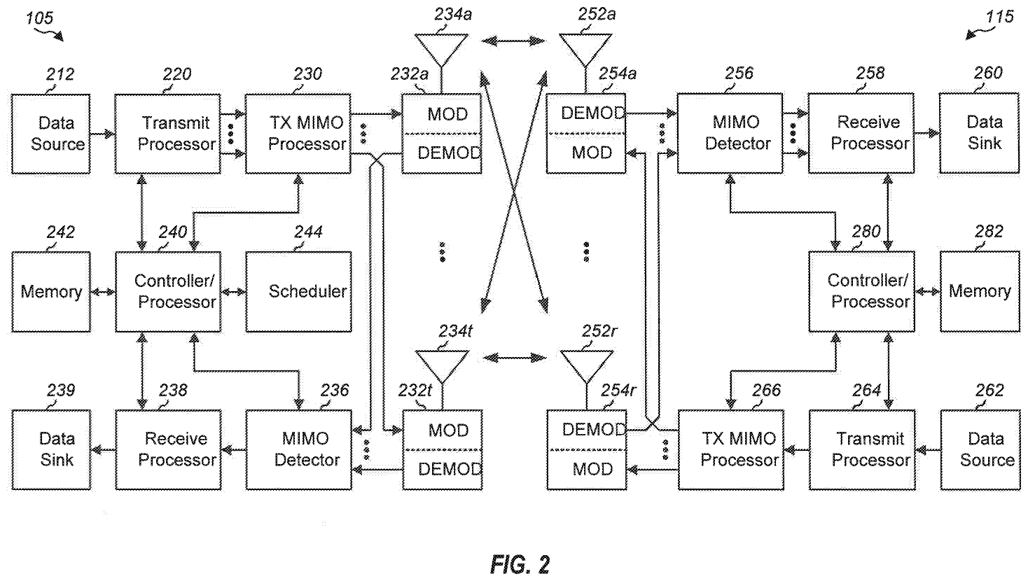

FIG. 2 shows a block diagram of a design of a base station 105 and a UE 115, which may be one of the base station and one of the UEs in FIG. 1. At the base station 105, a transmit processor 220 may receive data from a data source 212 and control information from a controller/processor 240. The control information may be for the PBCH, PCFICH, PHICH, PDCCH, EPDCCH, MPDCCH etc. The data may be for the PDSCH, etc. The transmit processor 220 may process (e.g., encode and symbol map) the data and control information to obtain data symbols and control symbols, respectively. The transmit processor 220 may also generate reference symbols, e.g., for the PSS, SSS, and cell-specific reference signal. A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. Downlink signals from modulators 232a through 232t may be transmitted via the antennas 234a through 234t, respectively.

At the UE 115, the antennas 252a through 252r may receive the downlink signals from the base station 105 and may provide received signals to the demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. A MIMO detector 256 may obtain received symbols from all the demodulators 254a through 254r, perform MIMO detection on the received symbols if applicable, and provide detected symbols. A receive processor 258 may process (e.g., demodulate, deinterleave, and decode) the detected symbols, provide decoded data for the UE 115 to a data sink 260, and provide decoded control information to a controller/processor 280.

On the uplink, at the UE 115, a transmit processor 264 may receive and process data (e.g., for the PUSCH) from a data source 262 and control information (e.g., for the PUCCH) from the controller/processor 280. The transmit processor 264 may also generate reference symbols for a reference signal. The symbols from the transmit processor 264 may be precoded by a TX MIMO processor 266 if applicable, further processed by the modulators 254a through 254r (e.g., for SC-FDM, etc.), and transmitted to the base station 105. At the base station 105, the uplink signals from the UE 115 may be received by the antennas 234, processed by the demodulators 232, detected by a MIMO detector 236 if applicable, and further processed by a receive processor 238 to obtain decoded data and control information sent by the UE 115. The processor 238 may provide the decoded data to a data sink 239 and the decoded control information to the controller/processor 240.

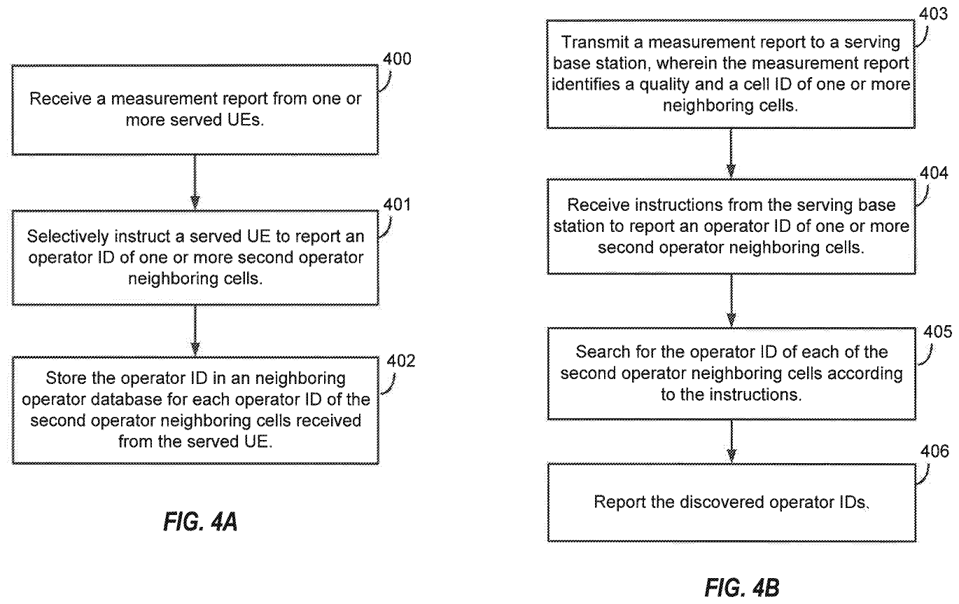

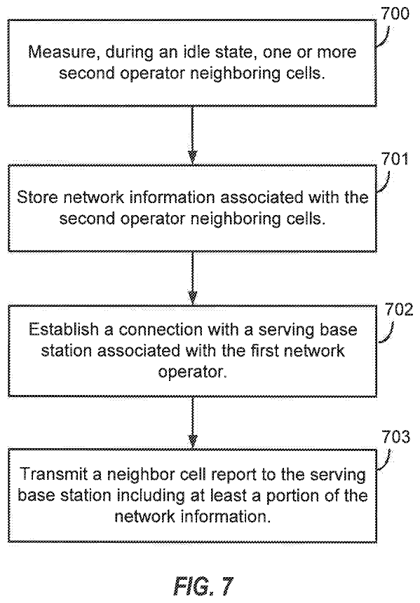

The controllers/processors 240 and 280 may direct the operation at the base station 105 and the UE 115, respectively. The controller/processor 240 and/or other processors and modules at the base station 105 may perform or direct the execution of various processes for the techniques described herein. The controllers/processor 280 and/or other processors and modules at the UE 115 may also perform or direct the execution of the functional blocks illustrated in FIGS. 4A, 4B, and 7, and/or other processes for the techniques described herein. The memories 242 and 282 may store data and program codes for the base station 105 and the UE 115, respectively. A scheduler 244 may schedule UEs for data transmission on the downlink and/or uplink.

Wireless communications systems operated by different network operating entities (e.g., network operators) may share spectrum. In some instances, a network operating entity may be configured to use an entirety of a designated shared spectrum for at least a period of time before another network operating entity uses the entirety of the designated shared spectrum for a different period of time. Thus, in order to allow network operating entities use of the full designated shared spectrum, and in order to mitigate interfering communications between the different network operating entities, certain resources (e.g., time) may be partitioned and allocated to the different network operating entities for certain types of communication.

For example, a network operating entity may be allocated certain time resources reserved for exclusive communication by the network operating entity using the entirety of the shared spectrum. The network operating entity may also be allocated other time resources where the entity is given priority over other network operating entities to communicate using the shared spectrum. These time resources, prioritized for use by the network operating entity, may be utilized by other network operating entities on an opportunistic basis if the prioritized network operating entity does not utilize the resources. Additional time resources may be allocated for any network operator to use on an opportunistic basis.

Access to the shared spectrum and the arbitration of time resources among different network operating entities may be centrally controlled by a separate entity, autonomously determined by a predefined arbitration scheme, or dynamically determined based on interactions between wireless nodes of the network operators.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen before talk (LBT) procedure such as a clear channel assessment (CCA) prior to communicating in order to determine whether the shared channel is available. A CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel and/or the acknowledge/negative-acknowledge (ACK/NACK) feedback for its own transmitted packets as a proxy for collisions.

Use of a medium-sensing procedure to contend for access to an unlicensed shared spectrum may result in communication inefficiencies. This may be particularly evident when multiple network operating entities (e.g., network operators) are attempting to access a shared resource.

In 5G network 100, base stations 105 and UEs 115 may be operated by the same or different network operating entities. In some examples, an individual base station 105 or UE 115 may be operated by more than one network operating entity. In other examples, each base station 105 and UE 115 may be operated by a single network operating entity. Requiring each base station 105 and UE 115 of different network operating entities to contend for shared resources may result in increased signaling overhead and communication latency.

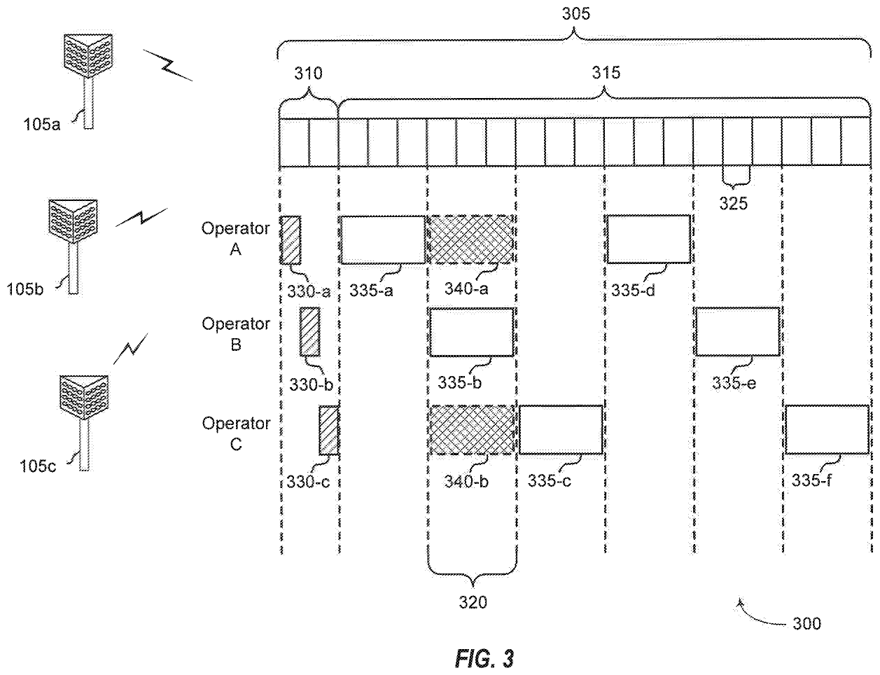

FIG. 3 illustrates an example of a timing diagram 300 for coordinated resource partitioning. The timing diagram 300 includes a superframe 305, which may represent a fixed duration of time (e.g., 20 ms). Superframe 305 may be repeated for a given communication session and may be used by a wireless system such as 5G network 100 described with reference to FIG. 1. The superframe 305 may be divided into intervals such as an acquisition interval (A-INT) 310 and an arbitration interval 315. As described in more detail below, the A-INT 310 and arbitration interval 315 may be subdivided into sub-intervals, designated for certain resource types, and allocated to different network operating entities to facilitate coordinated communications between the different network operating entities. For example, the arbitration interval 315 may be divided into a plurality of sub-intervals 320. Also, the superframe 305 may be further divided into a plurality of subframes 325 with a fixed duration (e.g., 1 ms). While timing diagram 300 illustrates three different network operating entities (e.g., Operator A, Operator B, Operator C), the number of network operating entities using the superframe 305 for coordinated communications may be greater than or fewer than the number illustrated in timing diagram 300.

The A-INT 310 may be a dedicated interval of the superframe 305 that is reserved for exclusive communications by the network operating entities. In some examples, each network operating entity may be allocated certain resources within the A-INT 310 for exclusive communications.

For example, resources 330-a may be reserved for exclusive communications by Operator A, such as through base station 105a, resources 330-b may be reserved for exclusive communications by Operator B, such as through base station 105b, and resources 330-c may be reserved for exclusive communications by Operator C, such as through base station 105c. Since the resources 330-a are reserved for exclusive communications by Operator A, neither Operator B nor Operator C can communicate during resources 330-a, even if Operator A chooses not to communicate during those resources. That is, access to exclusive resources is limited to the designated network operator. Similar restrictions apply to resources 330-b for Operator B and resources 330-c for Operator C. The wireless nodes of Operator A (e.g, UEs 115 or base stations 105) may communicate any information desired during their exclusive resources 330-a, such as control information or data.

When communicating over an exclusive resource, a network operating entity does not need to perform any medium sensing procedures (e.g., listen-before-talk (LBT) or clear channel assessment (CCA)) because the network operating entity knows that the resources are reserved. Because only the designated network operating entity may communicate over exclusive resources, there may be a reduced likelihood of interfering communications as compared to relying on medium sensing techniques alone (e.g., no hidden node problem). In some examples, the A-INT 310 is used to transmit control information, such as synchronization signals (e.g., SYNC signals), system information (e.g., system information blocks (SIBs)), paging information (e.g., physical broadcast channel (PBCH) messages), or random access information (e.g., random access channel (RACH) signals). In some examples, all of the wireless nodes associated with a network operating entity may transmit at the same time during their exclusive resources.

In some examples, resources may be classified as prioritized for certain network operating entities. Resources that are assigned with priority for a certain network operating entity may be referred to as a guaranteed interval (G-INT) for that network operating entity. The interval of resources used by the network operating entity during the G-INT may be referred to as a prioritized sub-interval. For example, resources 335-a may be prioritized for use by Operator A and may therefore be referred to as a G-INT for Operator A (e.g., G-INT-OpA). Similarly, resources 335-b may be prioritized for Operator B, resources 335-c may be prioritized for Operator C, resources 335-d may be prioritized for Operator A, resources 335-e may be prioritized for Operator B, and resources 335-f may be prioritized for operator C.

The various G-INT resources illustrated in FIG. 3 appear to be staggered to illustrate their association with their respective network operating entities, but these resources may all be on the same frequency bandwidth. Thus, if viewed along a time-frequency grid, the G-INT resources may appear as a contiguous line within the superframe 305. This partitioning of data may be an example of time division multiplexing (TDM). Also, when resources appear in the same sub-interval (e.g., resources 340-a and resources 335-b), these resources represent the same time resources with respect to the superframe 305 (e.g., the resources occupy the same sub-interval 320), but the resources are separately designated to illustrate that the same time resources can be classified differently for different operators.

When resources are assigned with priority for a certain network operating entity (e.g., a G-INT), that network operating entity may communicate using those resources without having to wait or perform any medium sensing procedures (e.g., LBT or CCA). For example, the wireless nodes of Operator A are free to communicate any data or control information during resources 335-a without interference from the wireless nodes of Operator B or Operator C.

A network operating entity may additionally signal to another operator that it intends to use a particular G-INT. For example, referring to resources 335-a, Operator A may signal to Operator B and Operator C that it intends to use resources 335-a. Such signaling may be referred to as an activity indication. Moreover, since Operator A has priority over resources 335-a, Operator A may be considered as a higher priority operator than both Operator B and Operator C. However, as discussed above, Operator A does not have to send signaling to the other network operating entities to ensure interference-free transmission during resources 335-a because the resources 335-a are assigned with priority to Operator A.

Similarly, a network operating entity may signal to another network operating entity that it intends not to use a particular G-INT. This signaling may also be referred to as an activity indication. For example, referring to resources 335-b, Operator B may signal to Operator A and Operator C that it intends not to use the resources 335-b for communication, even though the resources are assigned with priority to Operator B. With reference to resources 335-b, Operator B may be considered a higher priority network operating entity than Operator A and Operator C. In such cases, Operators A and C may attempt to use resources of sub-interval 320 on an opportunistic basis. Thus, from the perspective of Operator A, the sub-interval 320 that contains resources 335-b may be considered an opportunistic interval (O-INT) for Operator A (e.g., O-INT-OpA). For illustrative purposes, resources 340-a may represent the O-INT for Operator A. Also, from the perspective of Operator C, the same sub-interval 320 may represent an O-INT for Operator C with corresponding resources 340-b. Resources 340-a, 335-b, and 340-b all represent the same time resources (e.g., a particular sub-interval 320), but are identified separately to signify that the same resources may be considered as a G-INT for some network operating entities and yet as an O-INT for others.

To utilize resources on an opportunistic basis, Operator A and Operator C may perform medium-sensing procedures to check for communications on a particular channel before transmitting data. For example, if Operator B decides not to use resources 335-b (e.g., G-INT-OpB), then Operator A may use those same resources (e.g., represented by resources 340-a) by first checking the channel for interference (e.g., LBT) and then transmitting data if the channel was determined to be clear. Similarly, if Operator C wanted to access resources on an opportunistic basis during sub-interval 320 (e.g., use an O-INT represented by resources 340-b) in response to an indication that Operator B was not going to use its G-INT, Operator C may perform a medium sensing procedure and access the resources if available. In some cases, two operators (e.g., Operator A and Operator C) may attempt to access the same resources, in which case the operators may employ contention-based procedures to avoid interfering communications. The operators may also have sub-priorities assigned to them designed to determine which operator may gain access to resources if more than operator is attempting access simultaneously.

In some examples, a network operating entity may intend not to use a particular G-INT assigned to it, but may not send out an activity indication that conveys the intent not to use the resources. In such cases, for a particular sub-interval 320, lower priority operating entities may be configured to monitor the channel to determine whether a higher priority operating entity is using the resources. If a lower priority operating entity determines through LBT or similar method that a higher priority operating entity is not going to use its G-INT resources, then the lower priority operating entities may attempt to access the resources on an opportunistic basis as described above.

In some examples, access to a G-INT or O-INT may be preceded by a reservation signal (e.g., request-to-send (RTS)/clear-to-send (CTS)), and the contention window (CW) may be randomly chosen between one and the total number of operating entities.

In some examples, an operating entity may employ or be compatible with coordinated multipoint (CoMP) communications. For example an operating entity may employ CoMP and dynamic time division duplex (TDD) in a G-INT and opportunistic CoMP in an O-INT as needed.

In the example illustrated in FIG. 3, each sub-interval 320 includes a G-INT for one of Operator A, B, or C. However, in some cases, one or more sub-intervals 320 may include resources that are neither reserved for exclusive use nor reserved for prioritized use (e.g., unassigned resources). Such unassigned resources may be considered an O-INT for any network operating entity, and may be accessed on an opportunistic basis as described above.

In some examples, each subframe 325 may contain 14 symbols (e.g., 250-μs for 60 kHz tone spacing). These subframes 325 may be standalone, self-contained Interval-Cs (ITCs) or the subframes 325 may be a part of a long ITC. An ITC may be a self-contained transmission starting with a downlink transmission and ending with a uplink transmission. In some embodiments, an ITC may contain one or more subframes 325 operating contiguously upon medium occupation. In some cases, there may be a maximum of eight network operators in an A-INT 310 (e.g., with duration of 2 ms) assuming a 250-μs transmission opportunity.

Although three operators are illustrated in FIG. 3, it should be understood that fewer or more network operating entities may be configured to operate in a coordinated manner as described above. In some cases, the location of the G-INT, O-INT, or A-INT within superframe 305 for each operator is determined autonomously based on the number of network operating entities active in a system. For example, if there is only one network operating entity, each sub-interval 320 may be occupied by a G-INT for that single network operating entity, or the sub-intervals 320 may alternate between G-INTs for that network operating entity and O-INTs to allow other network operating entities to enter. If there are two network operating entities, the sub-intervals 320 may alternate between G-INTs for the first network operating entity and G-INTs for the second network operating entity. If there are three network operating entities, the G-INT and O-INTs for each network operating entity may be designed as illustrated in FIG. 3. If there are four network operating entities, the first four sub-intervals 320 may include consecutive G-INTs for the four network operating entities and the remaining two sub-intervals 320 may contain O-INTs. Similarly, if there are five network operating entities, the first five sub-intervals 320 may contain consecutive G-INTs for the five network operating entities and the remaining sub-interval 320 may contain an O-INT. If there are six network operating entities, all six sub-intervals 320 may include consecutive G-INTs for each network operating entity. It should be understood that these examples are for illustrative purposes only and that other autonomously determined interval allocations may be used.

It should be understood that the coordination framework described with reference to FIG. 3 is for illustration purposes only. For example, the duration of superframe 305 may be more or less than 20 ms. Also, the number, duration, and location of sub-intervals 320 and subframes 325 may differ from the configuration illustrated. Also, the types of resource designations (e.g., exclusive, prioritized, unassigned) may differ or include more or less sub-designations.

In unlicensed bands, there is a potential for overlapping networks from multiple network operators. With such overlap, a scenario may arise in which the signal strength of a current operator network is not very good while within a strong coverage area of another operator's network. 3GPP operations generally provide for handover within the same network, such that handover from within the same network on the same frequency is prioritized over establishing connection to other operators. This preference for intra-network handover is due to the nature of cellular frequencies being licensed to a single operator. This procedure may result in stickiness within networks while degrading performance of both the host network and neighboring networks. As wireless communications introduce access through unlicensed networks, the smaller geographic footprint of such unlicensed networks suggest the potential for optimizing inter-operator handovers.

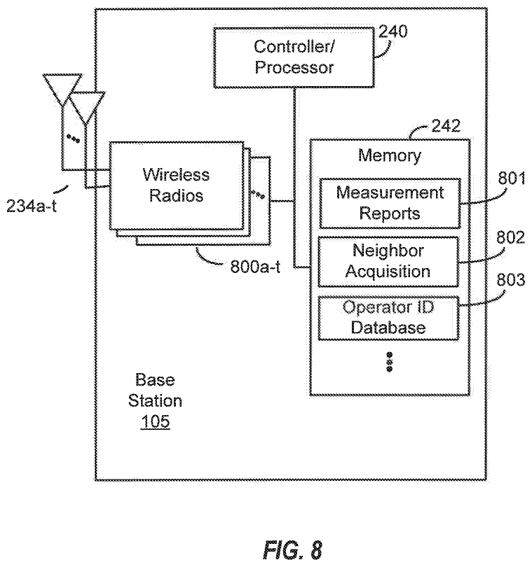

FIG. 4A is a block diagram illustrating example blocks executed by a base station to implement one aspect of the present disclosure. The example blocks will also be described with respect to base station 105 as illustrated in FIG. 8. FIG. 8 is a block diagram illustrating base station 105 configured according to one aspect of the present disclosure. Base station 105 includes the structure, hardware, and components as illustrated for base station 105 of FIG. 2. For example, base station 105 includes controller/processor 240, which operates to execute logic or computer instructions stored in memory 242, as well as controlling the components of base station 105 that provide the features and functionality of base station 105. Base station 105, under control of controller/processor 240, transmits and receives signals via wireless radios 800a-t and antennas 234a-t. Wireless radios 800a-t includes various components and hardware, as illustrated in FIG. 2 for base station 105, including modulator/demodulators 232a-t, MIMO detector 236, receive processor 238, transmit processor 220, and TX MIMO processor 230.

At block 400, a base station receives a measurement report from one or more served UEs of one or more neighboring cells, wherein the base station is operated by a first network operator. As a normal operation, base stations will typically receive measurement reports from served UEs for various reasons, such as connection management and handover. The measurement report may include received signal strength measurements from various neighboring cells and a cell ID of the neighbor cell. A base station, such as base station 105, would receive the transmitted measurement report via antennas 234a-t and wireless radios 800a-t and store at measurement reports 801, in memory 242.

At block 401, the base station selectively instructs a served UE of the one or more served UEs to report an operator ID of one or more second operator neighboring cells. After this report, base station 105 may selectively configure a UE to read the system information signals, such as the remaining minimum system information (RMSI), transmitted from a different operator's cell to obtain the operator ID. Under control of controller/processor 240, base station 105 executes neighbor acquisition logic 802, stored in memory 242. The execution environment of neighbor acquisition logic 802 provides for the functionality of base station 105 to selectively instruct served UEs to search for and report operator IDs of neighboring operator cells. An operator ID can be any number of different signaled identifiers, such as the public land mobile number (PLMN) ID, participating service provider (PSP) ID, neutral host ID, or other similar forms of operator identification. Under the execution environment of neighbor acquisition logic 802, base station 105 may selectively instruct various served UEs based on different criteria. For example, with a geographic criteria, when the UE is at the coverage edge of base station 105, base station 105 may instruct this UE to search neighboring operator cells for their operator IDs. A time criteria may also be used to collect based on various time periods. The energy cost to the UE is not negligible, so such instructions for inter-carrier searches may be limited through use of such criteria. Base station 105 transmits such instruction signals to the served UEs via wireless radios 800a-t and antennas 234a-t.

At block 402, the base station stores the operator ID in an neighboring operator database for each operator ID of the one or more second operator neighboring cells received from the served UE. As the instructed UEs obtain the operator IDs of the neighboring operator cells, the reported IDs are stored locally at base station 105 in operator ID database 803, in memory 242, to slowly build up a repository of neighbor cells.

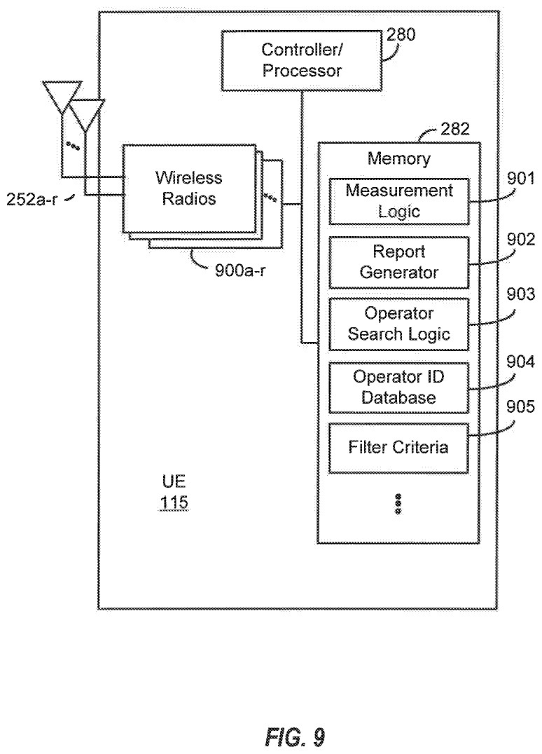

FIG. 4B is a block diagram illustrating example blocks executed by a UE to implement one aspect of the present disclosure. The example blocks will also be described with respect to UE 115 as illustrated in FIG. 9. FIG. 9 is a block diagram illustrating UE 115 configured according to one aspect of the present disclosure. UE 115 includes the structure, hardware, and components as illustrated for UE 115 of FIG. 2. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 900a-r and antennas 252a-r. Wireless radios 900a-r includes various components and hardware, as illustrated in FIG. 2 for UE 115, including modulator/demodulators 254a-r, MIMO detector 256, receive processor 258, transmit processor 264, and TX MIMO processor 266.

At block 403, a UE transmits a measurement report to a serving base station, wherein the measurement report identifies a quality and a cell ID of one or more neighboring cells. During normal operation, a UE, such as UE 115 executes, under control of controller/processor 280, measurement logic 901. The execution environment of measurement logic 901 provides UE 115 functionality to measure neighboring cells within its own network operator and reports the reference signal receive power (RSRP) to the serving base station along with cell ID. UE 115, in execution of report generator 902, generates the measurement report resulting from the execution environment of measurement logic 901, and transmits the report to the serving base station via wireless radios 900a-r and antennas 252a-r. This measurement report information is used, as noted above, by the base station for at least connection and handover management.

At block 404, the UE receives instructions from the serving base station to report an operator ID of one or more second operator neighboring cells, wherein the one or more second operator neighboring cells are each operated by at least one other network operator other than the first network operator. According to the aspects described herein, when the base station determines to instruct the UE to search neighbor operator cells, it not only signals UE 115 to measure its own covered frequencies (e.g., the frequencies assigned to the current network operator), but also to measure other frequencies on which it may be aware of the presence of neighbor networks from other operators. Such a mechanism creates a type of inter-operator self-organizing network functionality, which may save served UEs, such as UE 115, power in the long run. UE 115 receives such instructions from the serving base station via antennas 252a-r and wireless radios 900a-r.

At block 405, the UE searches for the operator ID of each of the one or more second operator neighboring cells according to the instructions. Upon receiving the additional search instructions from the base station, UE 115, under control of controller/processor 280, executes operator search logic 903, stored in memory 282. The execution environment of operator search logic 903, allows UE 115 to attempt to obtain the operator IDs of the neighboring operator cells by reading the RMSI in the additional frequencies. However, in some scenarios, there may only be partial system information signaled in the RMSI. In such scenarios, UE 115 may attempt to read other system information signals to determine the full set of operator information, such as the master information block (MIB), system information blocks (SIBs), physical broadcast channel (PBCH), and even neighboring reference signals, such as the channel state information reference signals (CSI-RS), and the like. In order to accommodate the additional search for UE 115, the serving base station can configure larger measurement gaps or schedule specific gaps when needed to enable this information reading. UE 115 may then transmit the discovered network information, including operator ID, for each of the network operators of the neighboring operator cells to the serving base station via wireless radios 900a-r and antennas 252a-r.

At block 406, the UE reports one or more operator IDs discovered in the searching. As UE 115 reads the system information signals from neighboring operator cells and obtains relevant operator IDs, the execution environment of operator search logic 903 triggers UE 115 to report the operator IDs to the serving base station, for example via wireless radios 900a-r and antennas 252a-r.

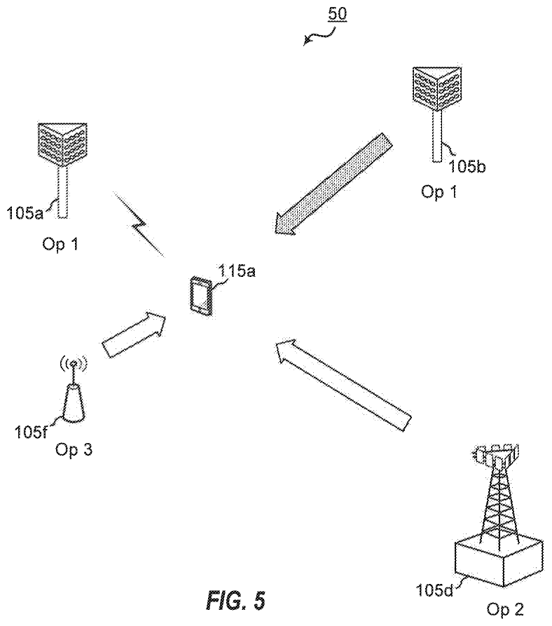

FIG. 5 is a block diagram illustrating an overlapping wireless network 50 including base station 105a and UE 115a of a first operator (Op 1), each configured according to aspects of the present disclosure. Within the area of overlapping wireless network 50, coverage areas of Op 1, a second operator (Op 2), and a third operator (Op 3) overlap. The different operators may be the same radio access technology (RAT) or may be different RATs having the overlapping coverage area. In normal operation, UE 115a performs regular signal measurements of neighboring cells within Op 1. For example, UE 115a measures the signal quality for the coverage area of base station 105b, also within Op 1. UE 115a would transmit the measurement report including the measurements of the signal quality received from base station 105b to its serving base station, base station 105a.

Where UE 115a meets the additional search criteria (e.g., geographic, time, interference, etc.), base station 105a signals UE 115a to perform an additional search of frequencies associated with other neighboring operator cells. UE 115a would then begin searching the frequencies of Op 2 and Op 3 for system information signaling. UE 115a may then read or determine the operator IDs for Op 2 and Op 3 from the system information signaling. As noted above, the operator ID may be obtained by UE 115a reading the RMSI from base stations 105d and 105f, respectively. However, base stations 105d and 105f may not transmit RMSI, or may not include enough system information in the transmitted RMSI to provide UE 115a the operator ID. In such cases, UE 115a would search other system information signals transmitted from base stations 105d and 105f, respectively.

The operator ID may be obtained in various ways and, according to additional aspects of the present disclosure, the operator ID may be included in full or as a hash value used in payload of a system signal, as a scrambling code of such signals, or added to the known sequence of the system signals. For example, a PLMN ID or a hash of PLMN ID may be added to the payload of the PBCH or may be used to scramble the PBCH. In another example, the full PLMN ID could be added to an extended PBCH channel or a hash of the PLMN ID may be added to the RMSI. In additional aspects, a full or hashed PLMN ID may be added to the CSI-RS sequence transmitted along with an synchronization signal block (SSB) by initializing the CSI-RS sequence with the PLMN ID or hashed PLMN ID.

Thus, in example operation as illustrated in FIG. 5, UE 115a may determine the operator ID of Op 3 by reading the full operator ID or a hash thereof either within a payload of a system information signal transmitted by base station 105f or by extracting the operator ID, which had been used to scramble the system information signal from base station 105f. Further, UE 115a may obtain the operator ID for Op 2 by reading the initial sequence of CSI-RS transmitted by base station 105d. After collecting the operator IDs for Op 2 and Op 3, UE 115a would report the operator IDs to base station 105a for including in the neighboring operator database.

FIG. 5 may also illustrate example implementation of additional aspects of the present disclosure used more directly for handover management. For example, in later operation, UE 115a measures and reports cell quality for another operator, such as Op 3, in a measurement report transmitted to base station 105a. In response, according to the described example aspect, base station 105a signals UE 115a the operator ID of a neighbor cell for handover consideration. The presently describe example aspect occurs after base station 105a has developed the database of neighboring operators through the additional aspects described above. By receiving the operator ID directly from its serving base station, base station 105a, UE 115a would not be required to make a special reading of the operator or network ID of the stronger cell encountered for the neighboring operator. This allows for a significant power and latency savings. UE 115a may then determine whether to initiate handover to the neighboring operator cell.

In a scenario in which base station 105a may know that the neighboring cell, base station 105d of Op 2, is on a deployment boundary and, thus, less likely to successfully serve UE 115a, base station 105a can signal the operator ID for Op 2 to UE 115a to consider or prioritize other operators (e.g., Op 3). UE 115a can then, based on its configuration, a database in its subscriber identification module (SIM), user feedback, or its internal knowledge, determine whether UE 115a should switch from Op 1 to another operator with a new operator or network ID. For example, as UE 115a determines to handover to Op 3 and base station 105f, UE 115a initiates a connection termination procedure with base station 105a. Once UE 115a initiates the connection termination with base station 105f, base station 105a may then safely terminate the connection and update the core network. In such connection termination cases, because UE 115a hands over to another operator (Op 3) without backhaul communications with base station 105a of Op 1, the core network of Op 1 may also immediately stop paging for UE 115a in addition to no longer expecting UE 115a to perform tracking area updates, if configured to do so periodically. After receiving a confirmation from base station 105a about connection termination, UE 115a can connect to base station 105f of Op 3 using a fresh connection setup procedure.

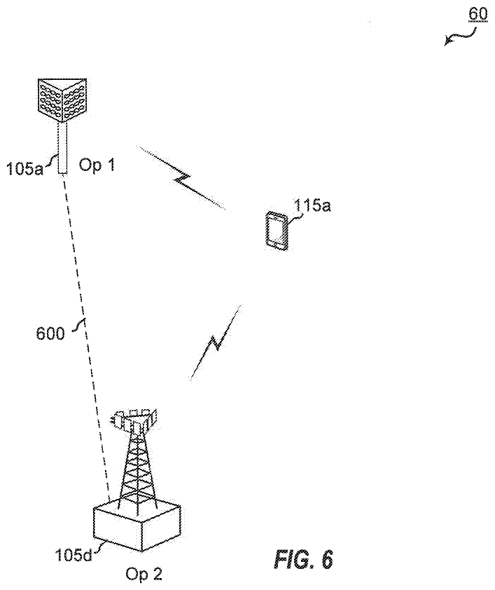

FIG. 6 is a block diagram illustrating an overlapping wireless network 60, with a base station 105a and UE 115a of a first operator (Op 1), each configured according to additional aspects of the present disclosure. In an alternative aspect, the core networks of different operators may communicate with each other. In such scenarios, backhaul connection 600 may exist directly or indirectly between base station 105a of Op 1 and base station 105d of Op 2. Thus, after determining to handover to Op 2, UE 115a transmits a handover request to current serving base station 105a. Base station 105a may then signal base station 105d over backhaul connection 600 to prepare for handover from UE 115a. Where, as illustrated, the core networks of different operators (Op 1 and Op 2) can communicate with each other, then base station 105a can perform a full inter-operator handover between the source (base station 105a) belonging to Op 1 and target (base station 105d) belonging to Op 2, including transfer. If multiple operators are available such as Op 2 and Op 3 (FIG. 5), then UE 115a can signal its preference to base station 105a with the handover request.

FIG. 7 is a block diagram illustrating example blocks executed to implement one aspect of the present disclosure. The example blocks will also be described with respect to UE 115 as illustrated in FIG. 9.

At block 700, a UE, during an idle state, measures one or more second operator neighboring cells, wherein the one or more second operator neighboring cells are each operated by at least one other network operator other than a first network operator associated with a last connection of the UE. While in an idle state, UE 115, under control of controller/processor 280, executes operator search logic 903. The execution environment of operator search logic 903 provides the functionality for UE 115 to measure the neighboring operator cells.

At block 701, the UE stores network information associated with the one or more second operator neighboring cells including signal quality information generated during the measurements. As UE 115 collects the network information associated with the cells that it measures during the idle state, it would maintain the network information locally at operator ID database 904, in memory 282.

At block 702, the UE establishes a connection with a serving base station associated with the first network operator. UE switches to a connected state with the serving base station to begin communications.

At block 703, the UE transmits a neighbor cell report to the serving base station, wherein the neighbor cell report includes at least a portion of the network information. Within the execution environment of operator search logic 903, when UE 115 connects to the serving base station, it can report the network information obtained during idle state stored at operator ID database 904. The list of cells that UE 115 reports can be filtered based on a predetermined criteria stored at filter criteria 905, in memory 282. Filter criteria 905 may include various criteria, such as a timer (e.g., information obtained within the last few seconds) or a geographical location of the serving base station (where only neighboring network information for neighboring cells within a certain distance from the serving base station location would be reported. This filtering criteria may be signaled to UE 115, via antennas 252a-r and wireless radios 900a-r, from either the serving base station or during a previous connected state (e.g., via RRC configuration signals).

With reference to FIG. 5, according to the example additional aspect described and illustrated in FIG. 7, if UE 115a were in an idle state, measurements of channel quality and operator IDs obtained during such measurements of signals from base station 105b (Op 1), base station 105d (Op 2), and base station 105f (Op 3) are obtained and stored at UE 115a during the idle state. As UE 115a establishes communication in a connected state with base station 105a (Op 1), UE 115a would transmit the list of cells to base station 105a. Filtering criteria communicated to UE 115a via RRC configuration signaling may filter some of the network information from the reported signals. For example, if a geographic criteria is used, the network information for base station 105d (Op 2) may be excluded as its location is beyond the predetermined distance from base station 105a. Similarly, if a timing criteria is used, network information from base station 105f (Op 3) may be excluded as UE 115a obtained the information at a time longer ago that the timing criteria indicates. Thus, the network information for Op 3 may be stale.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIGS. 4A, 4B, and 7 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
transmitting, by a user equipment (UE), a measurement report to a serving base station, wherein the measurement report identifies a quality and a cell identifier (ID) of one or more neighboring cells;
receiving, by the UE, instructions from the serving base station to report an operator identifier (ID) of one or more second operator neighboring cells, wherein the one or more second operator neighboring cells are each operated by at least one other network operator other than the first network operator;
searching, by the UE, for the operator ID of each of the one or more second operator neighboring cells according to the instructions; and
reporting, by the UE, one or more operator IDs discovered in the searching.

2. The method of claim 1, wherein the instructions includes:
identification of a set of frequencies for the searching, wherein the set of frequencies is not associated with coverage of the first network operator.

3. The method of claim 1, wherein the searching includes:
reading, by the UE, system information signals transmitted by the one or more second operator neighboring cells, wherein the system information signals includes the operator ID.

4. The method of claim 3,
wherein the operator ID includes one of:
a public land mobile number (PLMN);
a participating service provider (PSP) ID; or
a neutral host ID, and
wherein the system information signals includes one or more of:
remaining minimum system information (RMSI);
physical broadcast channel (PBCH);
system information block (SIB);
master information block (MIB);
channel state information reference signal (CSI-RS).

5. The method of claim 3, wherein the reading the system information signals includes one of:
reading a payload of the system information signals for the operator ID;
extracting the operator ID from the system information signals, wherein the system information signals are received at the UE scrambled with the operator ID; or
reading a predetermined signal sequence of the system information signals, wherein the predetermined signal sequence corresponds to the operator ID.

6. The method of claim 3, wherein a form of the operator ID included in the system information signals includes one of:
a hash of the operator ID; or
a full version of the operator ID.

7. The method of claim 1, further including:
receiving, by the UE, one or more local operator IDs from the serving base station;
evaluating, by the UE, at least one second operator neighboring cells associated with the one or more local operator IDs for handover from the serving base station;
signaling, by the UE, initiation of termination of a current connection with the serving base station in response to a determination to handover to a second operator neighboring cell of the at least one second operator neighboring cells; and
establishing, by the UE, a new connection with the second operator neighboring cell.

8. The method of claim 7, further including:
transmitting, by the UE, another measurement report, wherein the another measurement report includes identification of the at least one second operator neighboring cells having one or more communication channels with signal quality above a threshold quality, wherein the receiving the one or more local operator IDs is in response to the transmitting the another measurement report.

9. The method of claim 7, further including:
determining, by the UE, the at least one second operator neighboring cells have a signal quality above a threshold quality; and
identifying, by the UE, a location of the UE at a cell edge of the serving base station, wherein the evaluating is performed in response to a local channel quality of the current connection falling below the threshold quality.

10. The method of claim 7, wherein the evaluating includes:
determining a condition at the UE that influences selection by the UE to handover from the first network operator, wherein the condition includes one or more of:
a database on the UE of network operators authorized for the UE including the at least one second operator neighboring cells;
input from a user of the UE to handover from the first network operator;
connection information at the UE associated with the at least one second operator neighboring cells; or
operator information at the UE associated with the at least one second operator neighboring cells.

11. A method of wireless communication, comprising:
measuring, by a user equipment (UE) during an idle state, one or more second operator neighboring cells, wherein the one or more second operator neighboring cells are each operated by at least one other network operator other than a first network operator associated with a last connection of the UE;
storing, by the UE, network information associated with the one or more second operator neighboring cells, wherein the network information includes signal quality information generated during the measuring;
establishing, by the UE, a connection with a serving base station associated with the first network operator; and
transmitting, by the UE, a neighbor cell report to the serving base station, wherein the neighbor cell report includes at least a portion of the network information.

12. The method of claim 11, further including:
filtering, by the UE, the network information according to a relevance criteria to create the at least the portion of the network information.

13. The method of claim 12, wherein the relevance criteria includes one of:
a predetermined window of time from the establishing the connection; or
a geographic location of each of the one or more second operator neighboring cells.

14. The method of claim 12, further including:
receiving, by the UE, the relevance criteria from the at least one other network operator, wherein the relevance criteria is received one of: from the serving base station during the establishing the connection, or during a prior connection to the at least one other network operator.

15. The method of claim 11, wherein the network information further includes operator identifier (ID) of the one or more second operator neighboring cells.

16. The method of claim 11, further including:
reading, by the UE, system information signals transmitted by the one or more second operator neighboring cells, wherein the system information signals includes the operator ID.

17. The method of claim 16, wherein the reading the system information signals includes one of:
reading a payload of the system information signals for the operator ID;
extracting the operator ID from the system information signals, wherein the system information signals are received at the UE scrambled with the operator ID; or
reading a predetermined signal sequence of the system information signals, wherein the predetermined signal sequence corresponds to the operator ID.

18. An apparatus configured for wireless communication, the apparatus comprising:
at least one processor; and
a memory coupled to the at least one processor,
wherein the at least one processor is configured:
to transmit, by a user equipment (UE), a measurement report to a serving base station, wherein the measurement report identifies a quality and a cell identifier (ID) of one or more neighboring cells;
to receive, by the UE, instructions from the serving base station to report an operator identifier (ID) of one or more second operator neighboring cells, wherein the one or more second operator neighboring cells are each operated by at least one other network operator other than the first network operator;
to search, by the UE, for the operator ID of each of the one or more second operator neighboring cells according to the instructions; and
to report, by the UE, one or more operator IDs discovered during execution of the configuration of the at least one processor to search.

19. The apparatus of claim 18, wherein the instructions includes:
identification of a set of frequencies for the configuration of the at least one processor to search, wherein the set of frequencies is not associated with coverage of the first network operator.

20. The apparatus of claim 18, wherein the configuration of the at least one processor to search includes configuration of the at least one processor to read, by the UE, system information signals transmitted by the one or more second operator neighboring cells, wherein the system information signals includes the operator ID.

21. The apparatus of claim 20, wherein the configuration of the at least one processor to read the system information signals includes configuration of the at least one processor to one of:
read a payload of the system information signals for the operator ID;
extract the operator ID from the system information signals, wherein the system information signals are received at the UE scrambled with the operator ID; or
read a predetermined signal sequence of the system information signals, wherein the predetermined signal sequence corresponds to the operator ID.

22. The apparatus of claim 18, further including configuration of the at least one processor:
to receive, by the UE, one or more local operator IDs from the serving base station;
to evaluate, by the UE, at least one second operator neighboring cells associated with the one or more local operator IDs for handover from the serving base station;
to signal, by the UE, initiation of termination of a current connection with the serving base station in response to a determination to handover to a second operator neighboring cell of the at least one second operator neighboring cells; and
to establish, by the UE, a new connection with the second operator neighboring cell.

23. The apparatus of claim 22, further including configuration of the at least one processor to transmit, by the UE, another measurement report, wherein the another measurement report includes identification of the at least one second operator neighboring cells having one or more communication channels with signal quality above a threshold quality, wherein the configuration of the at least one processor to receive the one or more local operator IDs is in response to execution of the configuration of the at least one processor to transmit the another measurement report.

24. The apparatus of claim 22, further including configuration of the at least one processor:
to determine, by the UE, the at least one second operator neighboring cells have a signal quality above a threshold quality; and
to identify, by the UE, a location of the UE at a cell edge of the serving base station, wherein the configuration of the at least one processor to evaluate is performed in response to a local channel quality of the current connection falling below the threshold quality.

25. The apparatus of claim 22, wherein the configuration of the at least one processor to evaluate includes configuration of the at least one processor:
to determine a condition at the UE that influences selection by the UE to handover from the first network operator, wherein the condition includes one or more of:
a database on the UE of network operators authorized for the UE including the at least one second operator neighboring cells;
input from a user of the UE to handover from the first network operator;
connection information at the UE associated with the at least one second operator neighboring cells; or
operator information at the UE associated with the at least one second operator neighboring cells.

26. An apparatus configured for wireless communication, the apparatus comprising:
at least one processor; and
a memory coupled to the at least one processor,
wherein the at least one processor is configured:
to measure, by a user equipment (UE) during an idle state, one or more second operator neighboring cells, wherein the one or more second operator neighboring cells are each operated by at least one other network operator other than a first network operator associated with a last connection of the UE;
to store, by the UE, network information associated with the one or more second operator neighboring cells, wherein the network information includes signal quality information generated during execution of the configuration of the at least one processor to measure;
to establish, by the UE, a connection with a serving base station associated with the first network operator; and
to transmit, by the UE, a neighbor cell report to the serving base station, wherein the neighbor cell report includes at least a portion of the network information.

27. The apparatus of claim 26, further including configuration of the at least one processor to filter, by the UE, the network information according to a relevance criteria to create the at least the portion of the network information.

28. The apparatus of claim 27, further including configuration of the at least one processor to receive, by the UE, the relevance criteria from the at least one other network operator, wherein the relevance criteria is received one of: from the serving base station during execution of the configuration of the at least one processor to establish the connection, or during a prior connection to the at least one other network operator.

29. The apparatus of claim 26, further including configuration of the at least one processor to read, by the UE, system information signals transmitted by the one or more second operator neighboring cells, wherein the system information signals includes the operator ID.

30. The apparatus of claim 29, wherein the configuration of the at least one processor to read the system information signals includes configuration of the at least one processor to one of:
read a payload of the system information signals for the operator ID;
extract the operator ID from the system information signals, wherein the system information signals are received at the UE scrambled with the operator ID; or
read a predetermined signal sequence of the system information signals, wherein the predetermined signal sequence corresponds to the operator ID.
